(19) United States
(12) Patent Application Publication
(10) Pub. No.: US 2026/0280382 A1
(43) Pub. Date: Sep. 17, 2026

(54) AIRCRAFT LANDING GEAR COMPRISING A WHEEL WITH INTEGRATED MAGNETIC BRAKING DEVICE AND AIRCRAFT EQUIPPED WITH SUCH A LANDING GEAR

(71) Applicant: SAFRAN LANDING SYSTEMS, Velizy-Villacoublay (FR)

(72) Inventors: Graeme Peter Arthur KLIM, MOISSY-CRAMAYEL (FR); Denilson Chumbo POPO, MOISSY-CRAMAYEL (FR); Lucas Fernand Jean-Marie SANTER, MOISSY-CRAMAYEL (FR)

(73) Assignee: SAFRAN LANDING SYSTEMS, Velizy-Villacoublay (FR)

(21) Appl. No.: 19/472,799

(22) PCT Filed: Apr. 5, 2024
(86) PCT No.: PCT/EP2024/059335

§ 371 Date: Oct. 6, 2025

(30) Foreign Application Priority Data
Apr. 7, 2023 (FR) FR2303510

(51) Int. Cl. H02K 7/104; B64C 25/34; B64C 25/42; H02K 1/17; H02K 7/14

(52) U.S. Cl. CPC H02K 7/104; B64C 25/34; B64C 25/42; H02K 1/17; H02K 7/14

(57) ABSTRACT

A landing gear includes a leg having an end carrying a shaft on which a wheel is mounted. The wheel includes a hub portion, a rim portion coaxial with the hub portion and connected to the hub portion by a web portion, and an eddy current magnetic braking device comprising a rotor which is made of electrically conductive material and which is rotatably connected to the wheel and a stator which is rotatably connected to the leg and which is rotatable relative to the rim portion and the rotor. The stator carries magnets that emit a magnetic flux that generates eddy currents in the rotor when the stator and the rotor are facing each other and in relative movement, and the rotor is in one piece with the rim portion.

### CROSS REFERENCE TO RELATED APPLICATIONS

This application is a National Stage of International Application No. PCT/EP2024/059335 filed Apr. 5, 2024, claiming priority based on French Patent Application No. FR2303510 filed Apr. 7, 2023 the contents of which being herein incorporated by reference in their entireties.

The present invention relates to the field of braking for vehicle wheels such as aircraft wheels. The invention applies more particularly to magnetic braking devices, that is to say devices in which a magnetic field is used to produce a braking force.

### BACKGROUND OF THE INVENTION

An aircraft wheel generally comprises a rim connected by a web to a hub mounted to rotate on a wheel support shaft (axle or spindle).

Friction braking devices are known, comprising a brake disc stack which is housed in a space extending between the rim and the hub and which comprises alternating rotor discs rotatably linked with the wheel and stator discs, stationary with respect to the wheel support. The braking device also comprises hydraulic or electromechanical actuators mounted on an actuator carrier and arranged to apply a controlled braking force to the stack of discs in such a way as to brake the rotation of the wheel.

Eddy current magnetic braking devices are further known, used for the braking of vehicle wheels, and more specifically, aircraft wheels. Document WO-A-2014/029962 de-scribes such a device comprising a rotor which is provided with magnets and which is attached to the wheel opposite an electromagnetic stator fixed with respect to the landing gear leg carrying the wheel.

The performances of an eddy current magnetic braking device generally depends on the power and dimensions of the magnets used. The braking device is therefore relatively heavy and bulky when high maximum braking power is required. That is the case, for example, for use on an aeroplane, where weight and space requirement are severe constraints.

### AIM OF THE INVENTION

The invention aims, in particular, to propose a landing gear comprising a wheel with eddy current magnetic braking device, at least partially overcoming the abovementioned disadvantages.

### SUMMARY OF THE INVENTION

To this end, the invention provides an aircraft landing gear comprising a wheel including at least a hub portion and a rim portion coaxial with the hub portion and connected to the hub portion by a web portion, the wheel including an eddy current magnetic braking device including a rotor rotatably connected to the wheel and a stator which is rotatable relative to the rim portion and the rotor and which carries a plurality of magnets capable of emitting a magnetic flux generating eddy currents in the rotor, made of electrically conductive material, when the stator and the rotor are facing each other and in relative movement. The rotor is integral with the rim portion.

Thus, at least part of the wheel and the rotor are manufactured in a single piece, for example in foundry or in additive manufacturing, which improves the integration of the rotor in the wheel and dispenses with the use of means for fixing the rotor to the rim. It is therefore possible to obtain a simpler, more compact and lighter structure than that of conventional braked wheels.

According to optional features, used individually or fully or partly in combination:
the rotor and the stator have radial surfaces facing each other and the magnets are positioned on the stator to emit a magnetic field between these surfaces parallel to a central axis of the wheel;
the rotor comprises a ring extending laterally relative to a lip of the rim portion and connected to said rim portion by a connecting portion, the connecting portion having a cross-section smaller than a cross-section of the ring of the rotor;
the rotor and the stator have axial surfaces facing each other and the magnets are positioned on the stator to emit a magnetic field between these surfaces perpendicularly to a central axis of the wheel;
the rotor comprises a tube which is coaxial to the hub portion and extends between the rim portion and the hub portion, the tube has an inner surface forming the axial surface of the rotor;
the rotor and the stator have first radial surfaces facing each other and the magnets comprise first magnets positioned on the stator for emitting a magnetic field between the first surfaces parallel to a central axis of the wheel and wherein the rotor and the stator also have second axial surfaces facing each other and the magnets comprise second magnets positioned on the stator for emitting a magnetic field between the second surfaces perpendicularly to a central axis of the wheel;
the rotor includes a tubular portion that projects from the rim portion;
the wheel includes massive heat storage portions in the vicinity of the rotor, said massive portions being integral with the rim portion;
the magnets are arranged in a Halbach pattern.

The invention also relates to an aircraft equipped with such a landing gear.

Other features and advantages of the invention will become apparent on reading the following description of particular and non-limiting embodiments of the invention.

### BRIEF DESCRIPTION OF THE DRAWINGS

Reference will be made to the accompanying drawings, among which:

FIG. 1 is a partial, schematic view of an aircraft equipped with landing gears according to the invention;

FIG. 2 is a schematic view in axial half-section of a wheel according to a first embodiment of the invention;

FIG. 3 is a partial diagrammatic view in perspective and in axial half-section of this wheel;

FIG. 4 is a view similar to that of FIG. 2 of a wheel according to a second embodiment of the invention;

FIG. 5 is a view similar to that of FIG. 2 of a wheel according to a third embodiment of the invention;

FIG. 6 is a diagrammatic view showing a possible arrangement of the magnets in a wheel according to the invention.

### DETAILED DESCRIPTION OF THE INVENTION

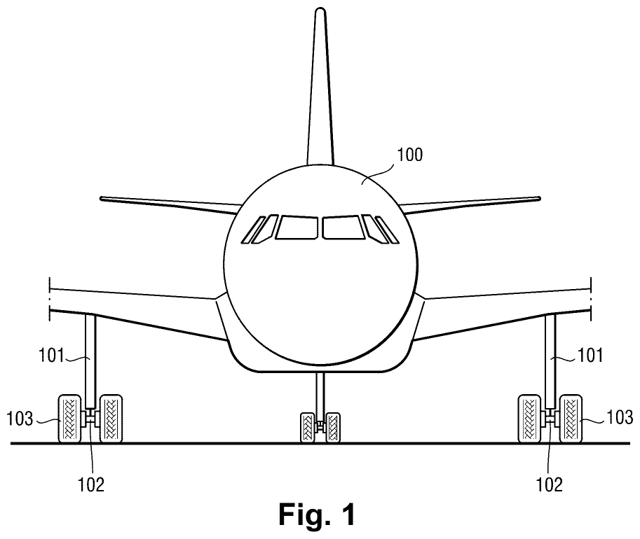

In reference to FIGS. 1 to 6, the invention is described in application to an aircraft 100 comprising landing gears 101. Each landing gear 101 comprises a leg having a first end hinged to a structure of the aircraft and, at the opposite, a second, free end, provided with two coaxial shafts 102 on each of which a wheel 103 is mounted to pivot. The landing gears 101 are here of the retractable type but the invention is applicable to fixed landing gears, or even to another type of vehicle such as a land vehicle.

In this example, each wheel 103 comprises, in a manner known per se, two half-wheels 103.1, 103.2 that are each made in a single piece and that are bolted to each other.

Each half-wheel 103.1, 103.2 comprises a hub portion 104.1, 104.2 and a rim portion 105.1, 105.2 connected to the hub portion 104.1, 104.2 by a web portion 106.1, 106.2. Each rim portion 105.1, 105.2 is annular in shape having a first annular edge secured to the web portion 106.1, 106.2 and an opposite second annular edge provided with a flange or lip 107.1, 107.2. We speak of half-wheel but also commonly of half-rim, half-web, half-hub even if these parts do not represent half of a wheel, rim, web, hub. In this example, each half-wheel 103.1, 103.2 is made of aluminium.

When the half-wheels 103.1, 103.2 are bolted together:
the hub portions 104.1, 104.2 form a hub that can be mounted to pivot on the shaft 102;
the rim portions 105.1, 105.2 form a rim adapted to receive a tire between the lips 107.1, 107.2;
the web portions 106.1, 106.2 are pressed against each other by the bolts and form a web transmitting forces between the hub and the rim.

The rim portion 105.1 extends facing the hub portion 104.1: they together define an annular space having one end at least partially closed by the web portion 106.1 and, at the opposite, an open end on the side of the lip 107.1. The wheels 103 are equipped with a magnetic braking device, generally referenced as 1.

The magnetic braking device 1 comprises a stationary element, or stator 2, and movable element, or rotor 3. The stator 2 and the rotor 3 are coaxial to the rim portion 105.1; the stator 2, the rotor 3 and the hub portion 104.1 therefore have collinear central axes. The stator 2 comprises a plurality of magnets capable of generating eddy currents in the rotor 3 when the stator 2 and the rotor 3 are separated by a small air gap and the rotor 3 pivots relative to the stator 2.

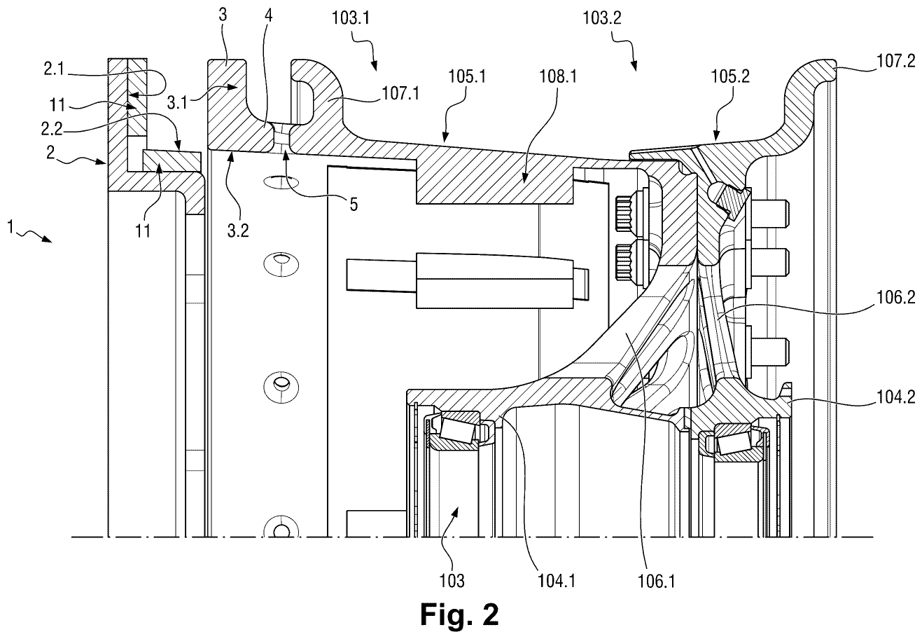

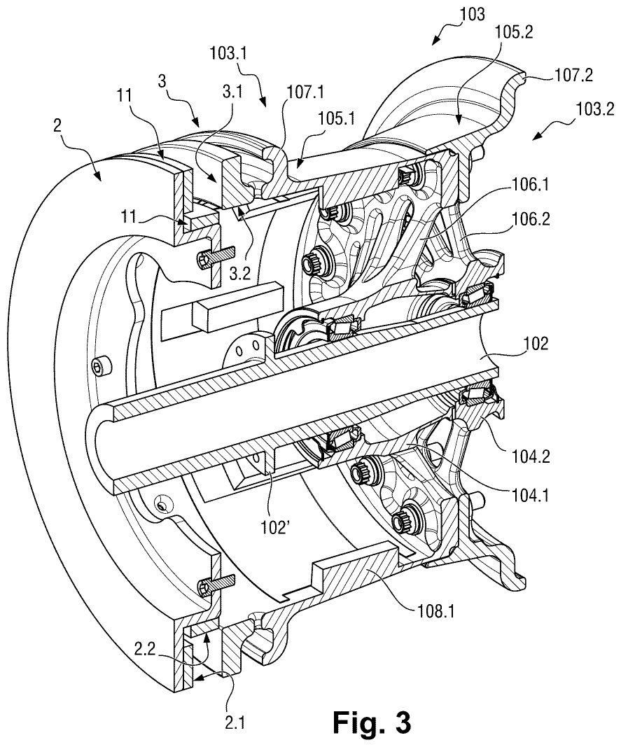

According to the invention, the rotor 3 is in one piece with the rim portion 105.1 and therefore in one piece with the half-wheel 103.1. The rotor 3 and the half-wheel 103.1 are therefore made of the same material, namely aluminium. According to the first embodiment shown in FIGS. 2 and 3, the rotor 3 is in the shape of a ring extending in front of the lip 107.1 coaxially therewith. The ring forming the rotor 3a:
a radial face defining a plane first main surface 3.1 of the rotor 3, which extends transversely to the central axis of the wheel 103 and which faces away from the lip 107.1;
an inner periphery defining a cylindrical second main surface 3.2 of the rotor 3, which extends axially and defines an inner periphery of the radial annular part of the ring;

The rotor 3 is connected to the rim portion 105.1 by a connecting ring 4 which extends in line with the second main surface 3.2 and the rim portion 105.1 beyond the lip 107.1.

The connecting ring 4 is pierced with radial holes 5 providing several functions and in particular limiting the mass of the wheel 103.

In this example, the stator 2 is in the form of a ring that extends facing the rotor 3 coaxially therewith and that has an internal axial flange. The stator 2 has an L-shaped cross section and comprises:
a radial face provided with a first series of magnets defining a first main surface 2.1 of the stator 2, which is flat and extends transversely to the central axis of the wheel 103 and which faces the rotor 3;
an inner periphery provided with a second series of magnets defining a cylindrical second main surface 2. 2 of the stator 2, which extends axially so as to be able to be engaged in the second main surface 3. 2 of the rotor 3.

The stator 2 is rotatably connected to the shaft 102, here by means of a fixing on a collar 102′ of the shaft 102 (see FIG. 3). Thus, the rotor 3 rotates on itself about its central axis in front of the stator 2 which is itself stationary: during this movement of the rotor 3 along a circumferential direction, the main surfaces 3.1, 3.2 re-main parallel to the main surfaces 2.1, 2.2.

Fixing the stator 2 on the collar 102′ allows the stator 2 to be slidably movable without rotation along an axial direction of the shaft 102 between a braking position and a position of free rotation of the wheel 103.

In its braking position, the stator 2 is brought closer to the rotor 3 to such an extent that the second main surface 2.2 of the stator 2 is engaged in the second main surface 3.2 of the rotor 3: the first main surfaces 2.1, 3.1 are separated from each other by a first predetermined air gap and the second main surfaces 2.2, 3.2 are separated from each other by a second predetermined air gap.

In its position of free rotation, the stator 2 is spaced apart from the rotor 3 to such an extent that the second main surface 2.2 of the stator 2 is disengaged from the second main surface 3.2 of the rotor 3: the first main surfaces 2.1, 3.1 are separated from each other by a third predetermined air gap and the second main surfaces 2.2, 3.2 are separated from each other by a fourth predetermined air gap.

In a manner known per se, at least one linear electromechanical actuator, not shown here, controllable by the pi-lot of the airplane, moves the stator 2 between the two aforementioned positions.

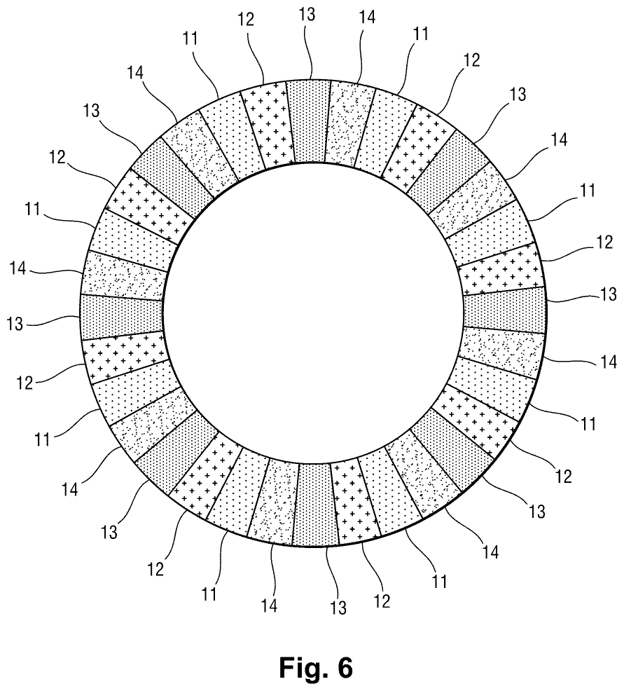

FIG. 6 shows the arrangement of the magnets. There are, for example 16 magnets, in this case, rare earth-based, and which are preferably fixed to a magnetic steel support, even to a non-magnetic support.

The magnets of each series here comprises first magnets 11, 13 having a first magnetisation vector substantially perpendicular to the first main face 2.1 and being separated in pairs by a second magnet 12, 14 having a second magnetisation vector substantially perpendicular to the first magnetisation vectors of the two first magnets 11, 13 between which the second magnet 12, 14 is located. It is reminded that the magnetisation vector indicates the direction of the magnetic field generated by a magnet and extends into the magnet from the South pole to the North pole. More precisely, the magnets 11, 12, 13, 14 have an-gular sector shapes and are arranged according to a Halbach pattern, alternately in the circumferential direction of the stator 2 as follows: a magnet 11, a magnet 12, a magnet 13, a magnet 14, a magnet 11, a magnet 12, a magnet 13, a magnet 14 and so on, etc. In this case:
each magnet 11 has its magnetisation vector emanating from the first main surface 2.1′ (its North pole emerges on the first main surface 2.1),
each magnet 12 has its magnetisation vector extending from the adjacent magnet 11 to the adjacent magnet 13,
each magnet 13 has its magnetisation vector entering the first main surface 2.1′ (its South pole emerges on the first main surface 2.1),
each magnet 14 has its magnetisation vector extending from the adjacent magnet 11 towards the adjacent magnet 13.

It is understood that the magnets 12, 14 arranged on each side of the same magnet 11 have their magnetisation vector oriented in opposite directions. The arrangement of the magnets 11, 12, 13, 14 makes it possible to optimise and to concentrate the magnetic flux produced by the magnets 11, 13 by reducing the return path of the magnetic flux which passes through the magnets 12, 14, and not through the support, the mass of which can be reduced, since there is no need to ensure a conduction function of the magnetic flux. The arrangement of the magnets 11, 12, 13, and 14 is the same on the main surfaces 2.1, 2.2.

It will be understood that, in order to cause braking, the electromechanical control actuators are controlled in order to bring the stator 2 into the braking position and that, in order to interrupt braking, the electromechanical control actuators are controlled in order to bring the stator 2 into the position of free rotation in which the rotor 3, and therefore the wheel 103, can rotate freely. In the braking position, the magnets generate in the rotor 3 eddy currents sufficient to generate a braking force on the rotor 3. The flow of eddy currents in the rotor 3 tends to cause heating of the rotor 3, all the more so when these currents have a high intensity. However, it is necessary to limit the heating of the rim portion 105.1 in the vicinity of the tire in order to limit the heating of the tire that could result therefrom. The rotor 3 in which the eddy currents flow is therefore designed to have a sufficient volume to store the heat released during braking. In addition, the connecting ring 4 has a cross-section (in a plane perpendicular to the axis of rotation of the wheel 103), here relatively thin and smaller than that of the rotor 3, which defines a restricted cross-section for the passage of heat to the rim portion 105.1. The holes 5 make it possible to further limit this flow section so that the braking heat can only be evacuated to a very limited extent by conduction towards the rim portion 105.1. Also, the holes 5 increase the exchange surface of the connecting ring 4 with the ambient air. The heat will therefore be evacuated from the rotor 3 by radiation, by contact with the air flux flowing over the rotor 3 due to the movement of the wheels and the aircraft and also by conduction towards the rest of the wheel.

In the free rotation position, the magnets do not make it possible to generate in the rotor 3 eddy currents sufficient to cause the braking of the rotor 3. It should be noted that, below a certain speed of rotation of the rotor 3, the braking torque is negligible, irrespective of the position of the stator 2. An additional brake must thus optionally be considered.

In this first embodiment, the annular space arranged between the hub portion 104.1 and the rim portion 105.1 is free and can accommodate a stack of stator and rotor discs of a conventional friction brake. To this end, the rim portion 105.1 would be provided internally with axial ribs 108.1 serving to rotationally connect the rotor disks to the wheel and a torsion tube connected to the shaft 102 would be provided externally with axial ribs serving to rotationally connect the stator disks to the shaft 102. A friction brake conventionally comprises a plurality of hydraulic or electromechanical actuators carried by an actuator carrier secured to the torque tube. By way of example, each electromechanical actuator comprises an electric motor and a pusher that can be moved by the electric motor to press the stack of discs. The electromechanical actuator is thus intended to produce a braking force controlled on the disc stack. One method for controlling braking devices is known from document FR-A-2953196, for example. It should be noted that, in this embodiment with friction brake, the discs serve as heat sinks and further limit the risk of heat transfer from the rotor to the tire.

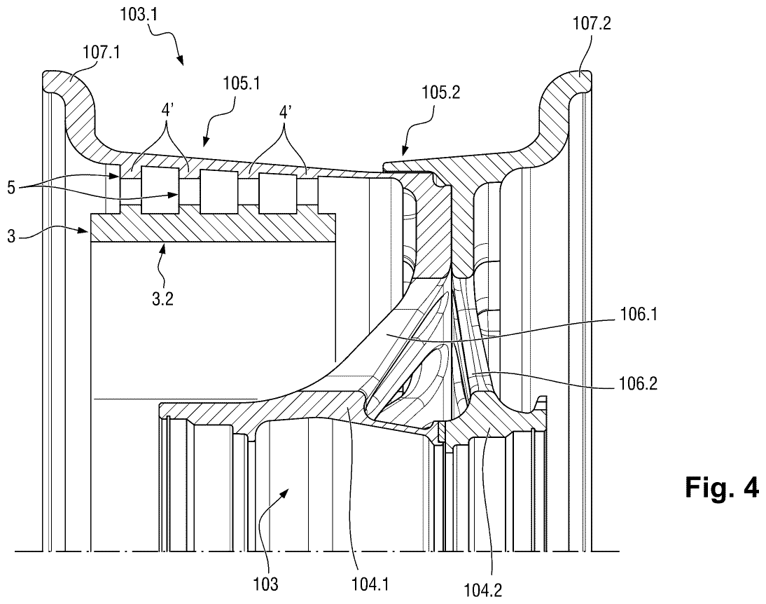

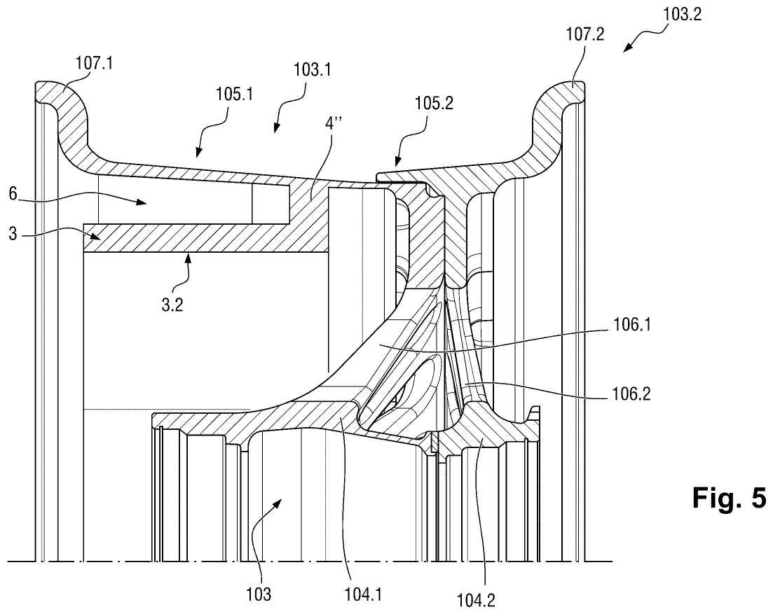

The elements which are identical or similar to those described above will have numerical reference which is identical to the latter in the description below of the second and third embodiments of the invention in reference to FIGS. 4 and 5.

In these two embodiments, the rotor 3 extends in the annular space arranged between the hub portion 104.1 and the rim portion 105.1 and has a tubular shape of circular section. In this case, the rotor 3 extends substantially from the lip 107.1 to the web portion 106.1 without being in contact with the latter. The rotor 3 has a cylindrical inner surface forming its main surface 3.2 and is fixed from the outside to the inner surface of the half-rim 105.1 by means of one or more connecting elements 4′, 4″ according to the embodiment. These connecting elements 4′, 4″ are in one piece with the half-wheel 103.1.

The stator is not shown in these figures but comprises at least one axial tubular part provided with magnets and defining an external cylindrical main surface intended to be engaged in the rotor 3 facing the second main surface 3.2. Optionally, the stator may also comprise a radial portion provided with magnets and intended to extend facing the front annular face of the rotor (the annular face of the rotor 3 closest to the lip 107.1).

The connecting elements 4′, 4′′ connecting the outside of the rotor 3 to the inner surface of the rim portion 105.1 will now be described.

According to the second embodiment, the connecting elements 4′ comprise annular fins extending circumferentially around the rotor 3, having an inner periphery secured to the rotor 3 and an outer periphery secured to the rim part 105.1. The annular fins 4′ are distributed over the length of the rotor 3 and are pierced with holes 5 which make it possible to limit the mass of the wheel and to increase the area of exchange with the ambient air.

The wheel part 103.1 in the second embodiment is preferably made by additive manufacturing.

According to the third embodiment, the connecting element 4″ is a single annular wing, relatively thick, extending circumferentially around the rear end of the rotor 3 (that adjacent to the web portion 106.1), having an inner periphery secured to the rotor 3 and an outer periphery secured to the rim portion 105.1.

An annular space 6 is arranged between the rotor 3 and the inner surface of the rim portion 105.1 to limit the mass of the wheel.

The wheel part 103.1 according to the third embodiment is preferably produced as a foundry.

It will be understood that, in all embodiments, the rotor 3 is in one piece with the wheel part 103.1 and that the half-wheel 103.1 serves in whole or in part as a heat sink, taking care to avoid heat transfers to the tire. The rotor 3, the ribs 108.1 and the annular wing 4″are relatively bulky: their volume is determined to give them sufficient heat capacity to form a massive heat storage part limiting the risk of heat transfer to the tire. The pierced annular fins 4′ will themselves promote dissipation of heat by the air flowing around the rotor 3.

Naturally, the invention is not limited to the embodiments described, but includes any variant entering into the scope of the invention such as defined by the claims.

In particular, the wheel may have a structure different to that described.

A rim portion (serving as a support for the tire) may be attached to a web portion and/or a web portion may be attached to a hub portion.

Instead of being formed of two half-wheels, the wheel can be a single part, made as a foundry or by additive manufacturing.

The wheel may be made of any electrically conductive material having mechanical properties compatible with the application being considered.

The shape, arrangement and dimensions of the magnets may be different to those described. For example, the magnets 11, 12, 13, and 14 may be identical to each other or occupy different surfaces with different widths and/or lengths. It is not mandatory to use a Halbach pattern.

The magnetic braking device can be with an axial flux (the rotor and the stator have only radial surfaces as their main surfaces), radial flux (the rotor and the stator have only axial surfaces as in FIGS. 4 and 5) or a combination of axial and radial fluxes (the rotor and the stator have axial and radial main surfaces as in FIGS. 2 and 3).

The invention applies to any rotor formed of a tubular portion in one piece with the rim portion. Thus, it will be understood that in the embodiments described, the rotor 3 comprises a tubular portion projecting from the rim portion 105.1 either laterally (ring of FIGS. 2 and 3) or towards the axis of rotation of the wheel (tube of FIGS. 4 and 5).

Generally speaking, the actuators can be electromechanical, hydromechanical or hydraulic, single or double-acting actuators. For a single-acting actuator, the power supply allows for forward movement of the pusher and an elastic member allows for return of the pusher. The number of actuators can be different from that mentioned. Preferably, at least three actuators symmetrically distributed about the axis of rotation of the wheel will be used to balance the axial forces exerted on the stators.

Other modes of actuating the magnetic brake can be envisaged: for example, electromagnetic by means of coils generating a magnetic field cancelling that of the permanent magnets, rotors and stators being axially fixed.

The invention can be used on any type of vehicle comprising a landing gear.

1. A landing gear comprising:
a leg having an end carrying a shaft on which a wheel is mounted,
wherein the wheel comprises:
a hub portion;
and a rim portion coaxial with the hub portion and connected to the hub portion by a web portion; and
an eddy current magnetic braking device, comprising a rotor which is made of electrically conductive material and which is rotatably connected to the wheel and a stator which is rotatably connected to the leg and which is rotatable relative to the rim portion and the rotor,
wherein the stator carries a plurality of magnets configured to emit a magnetic flux that generates eddy currents in the rotor when the stator and the rotor are facing each other and in relative movement, and
wherein the rotor is in one piece with the rim portion.

2. The landing gear according to claim 1, wherein the rotor and the stator have first main surfaces that are radial and facing each other, and the plurality of magnets are positioned on the stator to emit a magnetic field between the first main surfaces parallel to a central axis of the wheel

3. The landing gear according to claim 1, wherein the rotor comprises a ring extending laterally with respect to a lip of the rim portion and connected to said rim portion by a connecting portion, the connecting portion having a cross-section smaller than a cross-section of the ring of the rotor.

4. The landing gear according to claim 1, wherein the rotor and the stator have second main axial surfaces that are axial and facing each other, and the plurality of magnets are positioned on the stator to emit a magnetic field between the second main surfaces perpendicularly to a central axis of the wheel.

5. The landing gear according to claim 4, wherein the rotor comprises a tube which is coaxial with the hub portion and extends between the rim portion and the hub portion the tube having an inner surface forming the second main surface of the rotor.

6. The landing gear according to claim 1, wherein the rotor and the stator have first main surfaces that are radial and facing each other, and the plurality of magnets comprise a first group of magnets positioned on the stator to emit a magnetic field between the first main surfaces parallel to a central axis of the wheel; and
wherein the rotor and the stator have second main surfaces that are axial and facing each other, and the plurality of magnets comprise a second group of magnets positioned on the stator to emit a magnetic field between the second main surfaces perpendicularly to a central axis of the wheel.

7. The landing gear according to claim 1, comprising massive heat storage portions in the vicinity of the rotor, said massive heat storage portions being in one piece with the rim portion.

8. The landing gear according to claim 1, wherein the rotor includes a tubular portion projecting from the rim portion

9. The landing gear according to claim 1, claims, wherein the plurality of magnets are arranged according to a Halbach pattern.

10. An aircraft comprising a structure on which at least one of the landing gear according to claim 1 is mounted.
